(19) United States
(12) Patent Application Publication
(10) Pub. No.: US 2020/0334553 A1
(43) Pub. Date: Oct. 22, 2020

(54) APPARATUS AND METHOD FOR PREDICTING ERROR OF ANNOTATION

(71) Applicant: ELECTRONICS AND TELECOMMUNICATIONS RESEARCH INSTITUTE, Daejeon (KR)

(72) Inventors: Hyunjin YOON, Daejeon (KR); Mi Kyong HAN, Daejeon (KR)

(21) Appl. No.: 16/854,002

(22) Filed: Apr. 21, 2020

(30) Foreign Application Priority Data
Apr. 22, 2019 (KR) 10-2019-0046624

(51) Int. Cl. G06N 5/04; G06N 20/00

(52) U.S. Cl. CPC G06N 5/04; G06N 20/00

(57) ABSTRACT

An apparatus and a method for predicting error possibility, including: generating a first annotation for input data for training by using an algorithm; performing a machine-learning for an annotation evaluation model based on the first annotation and a correction history for the first annotation; generating a second annotation for input data for evaluating by using the algorithm; and predicting the error probability of the second annotation based on the annotation evaluation model are provided.

### CROSS-REFERENCE TO RELATED APPLICATION

This application claims priority to and the benefit of Korean Patent Application No. 10-2019-0046624 filed in the Korean Intellectual Property Office on Apr. 22, 2019, the entire content of which is incorporated herein by reference.

### BACKGROUND OF THE INVENTION

### 1. Field of the Invention

The present description relates to an apparatus and a method for predicting an error possibility in annotations for input data.

### 2. Description of Related Art

As the artificial intelligence (AI) performance increases and application fields diversify, the demand for a new AI algorithm is increasing. In the training data which is an essential element for developing an AI algorithm, annotations such as objects, events, annotations, and categories are added to image, video, audio, and text data.

Initially, the training data was constructed by manually adding the annotations to the image, video, audio, and/or text data. As the type of the training data are diversified and complicated, it is physically limited to manually generate the annotations.

The technique of generating the annotations through an automated algorithm may include errors in the results, so the user needs to find the error in the data and correct it manually.

The above information disclosed in this Background section is only for enhancement of understanding of the background of the invention, and therefore it may contain information that does not form the prior art that is already known in this country to a person of ordinary skill in the art.

### SUMMARY OF THE INVENTION

An exemplary embodiment of the exemplary embodiment provides an apparatus for predicting error possibility of an annotation for input data.

Another embodiment of the exemplary embodiment provides a method for predicting the error possibility of the annotation for the input data.

Yet another embodiment of the exemplary embodiment provides another apparatus for predicting the error possibility of the annotation for the input data

According to an exemplary embodiment, an apparatus for predicting error possibility in an annotation for input data is provided. The apparatus includes: an annotation generating unit configured to generate a first annotation for input data for training and a second annotation for input data for evaluation by using an annotation algorithm; an annotation learning unit configured to perform a machine-learning for an annotation evaluation model based on the first annotation and a correction history for the first annotation; and an annotation error predicting unit configured to predict the error probability of the second annotation based on the annotation evaluation model.

The apparatus may further include an annotation correction unit including: a user interface configured to receive the correction history for the first annotation or provides user with the error possibility of the second annotation; and a storage unit configured to store the correction history.

The annotation learning unit may be configured to perform the machine-learning for a binary classification model as the annotation evaluation model, wherein the binary classification model predicts first input data for which correction has been performed among the input data for training as an error occurrence class for the first annotation and predicts second input data for which correction has not been performed among the input data for training as a no error occurrence class for the first annotation.

The annotation learning unit may be configured to perform the machine-learning for a multi classification model as the annotation evaluation model, wherein the multi classification model classifies errors of the first annotation into a correction class, a deletion class, an addition class, and no error class.

The annotation error predicting unit may be configured to calculate an error value which indicates that an error exists in the second annotation.

The annotation error predicting unit may be configured to calculate an error value which indicates that a type of an error that occurs in the second annotation is one of the correction class, the deletion class, and the addition class.

According to another exemplary embodiment, a method for predicting error possibility in an annotation for input data is provided. The method includes: generating a first annotation for input data for training by using an annotation algorithm; performing a machine-learning for an annotation evaluation model based on the first annotation and a correction history for the first annotation; generating a second annotation for input data for evaluating by using the annotation algorithm; and predicting the error probability of the second annotation based on the annotation evaluation model.

After the predicting of the error probability of the second annotation based on the annotation evaluation model, the method may further include: providing the error possibility of the second annotation to a user, and receiving the correction history for the second annotation from the user.

The performing of the machine-learning for the annotation evaluation model may include: performing the machine-learning for a binary classification model as the annotation evaluation model, wherein the binary classification model predicts first input data for which correction has been performed among the input data for training as an error occurrence class for the first annotation and predicts second input data for which correction has not been performed among the input data for training as a no error occurrence class for the first annotation.

The performing of the machine-learning for the annotation evaluation model may include: performing the machine-learning for a multi classification model as the annotation evaluation model, wherein the multi classification model classifies errors of the first annotation into a correction class, a deletion class, an addition class, and no error class.

The predicting of the error possibility in the second annotation may include calculating an error value which indicates that an error exists in the second annotation.

The predicting of the error possibility in the second annotation may include calculating an error value which indicates that a type of an error that occurs in the second annotation is one of the correction class, the deletion class, and the addition class.

According to yet another exemplary embodiment, an apparatus for predicting error possibility in an annotation for input data is provided. The apparatus includes: a processor and a memory, wherein the processor executes a program stored in the memory to perform: generating a first annotation for input data for training by using an annotation algorithm;

performing a machine-learning for an annotation evaluation model based on the first annotation and a correction history for the first annotation; generating a second annotation for input data for evaluating by using the annotation algorithm; and predicting the error probability of the second annotation based on the annotation evaluation model.

### BRIEF DESCRIPTION OF THE DRAWINGS

FIG. 1 is a block diagram illustrating an apparatus for predicting error possibility according to an exemplary embodiment.

FIG. 2 is a flowchart illustrating a method for predicting error possibility according to an exemplary embodiment.

FIG. 3A is a diagram illustrating input data for training used for the apparatus for predicting error possibility according to an exemplary embodiment.

FIG. 3B is a diagram illustrating a generated annotation for input data for training by the annotation generating unit of the apparatus for predicting the error possibility according to an exemplary embodiment.

FIG. 3C is a diagram illustrating a corrected annotation through the annotation correction unit of the apparatus for predicting the error possibility according to an exemplary embodiment.

FIG. 4 is a table showing the annotation correction history stored in the annotation correction unit according to an exemplary embodiment.

FIG. 5 is a block diagram of an apparatus for predicting error possibility of an annotation according to another exemplary embodiment.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention.

Accordingly, the drawings and description are to be regarded as illustrative in nature and not restrictive, and like reference numerals designate like elements throughout the specification. In this specification, redundant description of the same constituent elements is omitted.

Also, in this specification, it is to be understood that when one component is referred to as being “connected” or “coupled” to another component, it may be connected or coupled directly to the other component or may be connected or coupled to the other component with another component intervening therebetween.

On the other hand, in this specification, it is to be understood that when one component is referred to as being “connected or coupled directly” to another component, it may be connected or coupled to the other component without another component intervening therebetween.

It is also to be understood that the terminology used herein is only used for the purpose of describing particular embodiments, and is not intended to limit the invention. Singular forms are to include plural forms unless the context clearly indicates otherwise. It will be further understood that terms “comprises” and “have” used in the present specification specify the presence of stated features, numerals, steps, operations, components, parts, or a combination thereof, but do not preclude the presence or addition of one or more other features, numerals, steps, operations, components, parts, or a combination thereof.

Also, as used herein, the term “and/or” includes any plurality of combinations of items or any of a plurality of listed items. In the present specification, “A or B” may include “A”, “B”, or “A and B”.

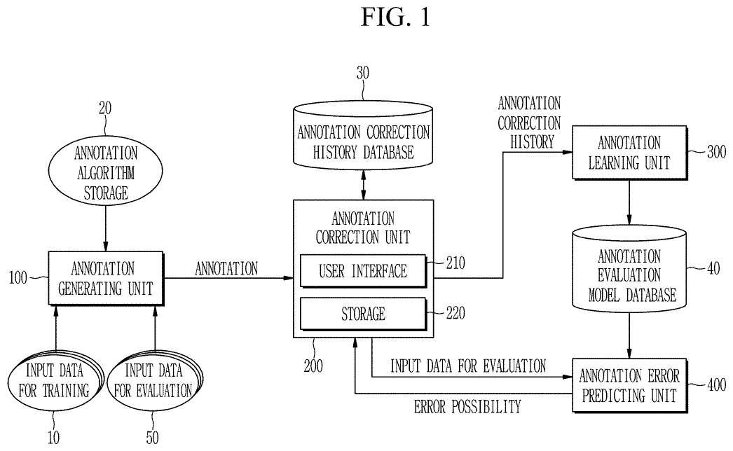

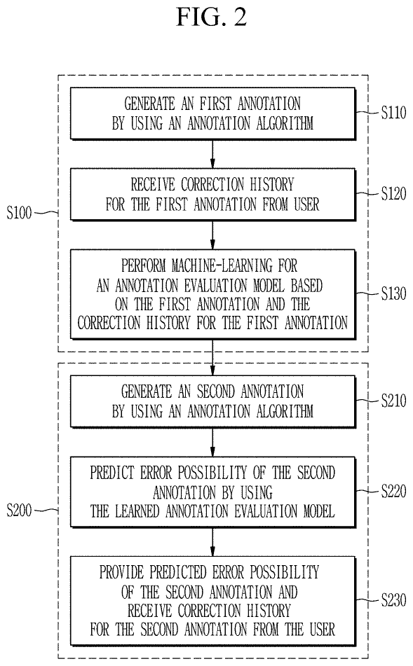

FIG. 1 is a block diagram illustrating an apparatus for predicting error possibility according to an exemplary embodiment. FIG. 2 is a flowchart illustrating a method for predicting error possibility according to an exemplary embodiment.

Referring to FIGS. 1 and 2, the apparatus for predicting error possibility according to the exemplary embodiment includes an annotation generating unit 100, an annotation correction unit 200, an annotation learning unit 300, and an annotation error predicting unit 400. The apparatus for predicting error possibility according to the exemplary embodiment may perform an error learning step of an annotation (S100) and an evaluation step of the annotation (S200).

Specifically, the annotation generating unit 100 may generate an annotation for input data for training 10 by using an annotation algorithm (S110).

The annotation algorithm is an algorithm stored in advance in annotation algorithm storage 20. According to an exemplary embodiment, the annotation algorithm may include a classification algorithm for classifying input data into a predetermined class, an object recognition algorithm for determining a class and a location of an object in an input image, a semantic segmentation algorithm for identifying an object in units of pixels from image data, an object tracking algorithm for tracking a moved position of an object in an input image, and an image annotation generation algorithm for generating a text annotation for input image data.

The annotation correction unit 200 may receive a correction history for the annotation generated for the input data for training 10 from a user (S120). The annotation generated for the input data for training 10 may be received from a user.

The annotation correction unit 200 may correct a part of the annotation or delete the entire annotation when an error occurs in the annotation automatically generated by the annotation generating unit 100 for the input data for training 10.

The annotation correction unit 200 may include an interface 210 which receives the correction history for the annotation generated for the input data 10 or provide the error possibility in the annotation generated for input data for evaluation 50 to a user.

The annotation correction unit 200 may further include a storage unit 220 which stores the correction history in which a modification history, a deletion history, and/or an adding history for the generated annotation is included. The user may add annotations that are not automatically generated through the user interface 210.

According to an exemplary embodiment, the annotation correction unit 200 may store the correction history by the user in a separate annotation correction history database 30.

The annotation learning unit 300 may perform a machine-learning for an annotation evaluation model based on the annotation generated for the input data for training 10 and the correction history for the annotation generated for the input data 10, to predict the error probability of the annotation (S130).

The annotation learning unit 300 may perform the machine-learning for a binary classification model or a multi classification model as the annotation evaluation model.

Specifically, the binary classification model may predict input data for which correction has been performed among the input data 10 as an error occurrence class for the annotation and predict input data for which correction has not been performed among the input data 10 as a no error occurrence class for the annotation.

The multi classification model may classify errors of the annotation for the input data 10 into a correction class, a deletion class, an addition class, and no error class.

The annotation generating unit 100 may generate an annotation for the input data for evaluation 50 by using the annotation algorithm (S210).

The annotation error predicting unit 400 may predict the error possibility of the annotation for the input data 50 by using the learned annotation evaluation model (S220).

The annotation error predicting unit 400 may calculate an error value which indicates that an error exists in the annotation for the input data 50 when the learned annotation evaluation model is the binary classification model.

The annotation error predicting unit 400 may calculate an error value which indicates that a type of an error that occurs in the annotation for the input data 50 is one of the correction class, the deletion class, and the addition class when the learned annotation evaluation model is the multi classification model.

The annotation correction unit 200 may provide the user with the error possibility of the annotation for the input data 50, and receive the correction history for the annotation for the input data 50 (S230). Specifically, the annotation correction unit 200 may provide error predicting result from the annotation error predicting unit 400 to the user through the user interface 210 when the annotation for the input data 50 is generated by the annotation generating unit 100. Through the user interface 210, the user can review and correct the annotations, for example, in the order of high error probabilities.

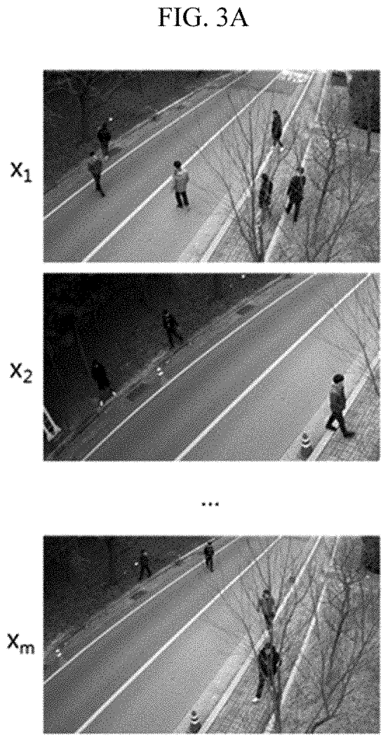

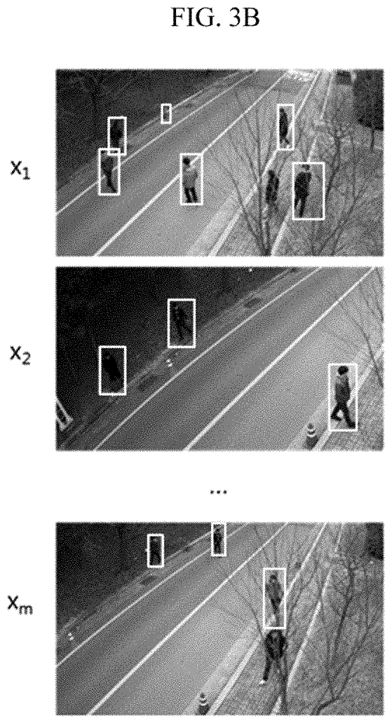

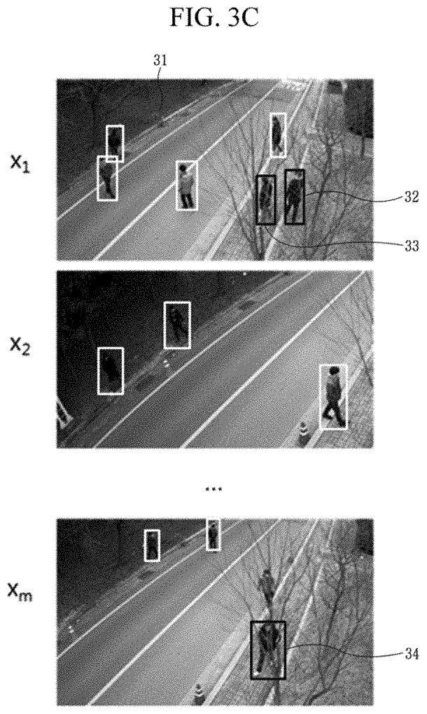

FIG. 3A is a diagram illustrating input data for training used for the apparatus for predicting error possibility according to an exemplary embodiment. FIG. 3B is a diagram illustrating a generated annotation for input data for training by the annotation generating unit of the apparatus for predicting the error possibility according to an exemplary embodiment. FIG. 3C is a diagram illustrating a corrected annotation through the annotation correction unit of the apparatus for predicting the error possibility according to an exemplary embodiment.

Referring to FIGS. 3A to 3C, as an example, the annotation generating unit 100 may use a pedestrian detection algorithm which detects a pedestrian area from the input data for training 10 as the annotation algorithm. As an example, the user may review the annotation errors occurring in the inputs x₁ and xₘ through the user interface 210 and directly correct the annotation errors.

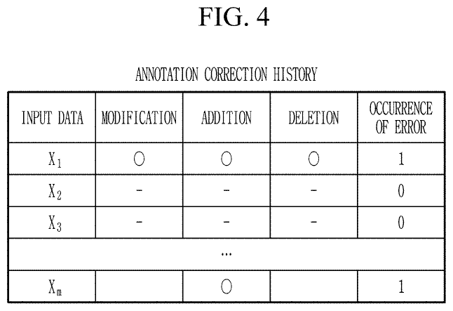

FIG. 4 is a table showing the annotation correction history stored in the annotation correction unit according to an exemplary embodiment.

Referring to FIGS. 3A to 3C and FIG. 4, among the annotations generated for the input data x₂, the annotation for the conical rabacon region 31 has been deleted, a size of one annotation 32 of the pedestrian annotations has been corrected. In addition, the occurrence of the error may be indicated by ‘1’ because the pedestrian annotation 33 for the tree branch region has been added. Since the annotations generated for the input data x₂ and x₃ have not been corrected, the occurrence of the error may be indicated by ‘0’. Since the annotation 34 for the input xₘ has been added by the user, the occurrence of the error may be indicated by ‘1’.

According to the aforementioned embodiment, since the user does not need to review all annotations for input data, the time required for the user to manually correct the annotations can be reduced. In addition, since the performance of the annotation algorithm used for automatically generating annotations can be evaluated, the annotation algorithm suitable for input data can be selected.

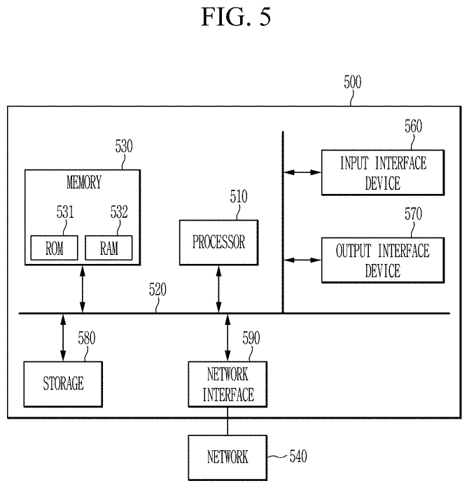

FIG. 5 is a block diagram of an apparatus for predicting error possibility of an annotation according to another exemplary embodiment.

The apparatus for predicting the error possibility of the annotation according to another exemplary embodiment may be implemented as a computer system, for example a computer readable medium. Referring to FIG. 5, a computer system 500 may include at least one of processor 510, a memory 530, an input interface unit 550, an output interface unit 560, and storage 540. The computer system 500 may also include a communication unit 520 coupled to a network. The processor 510 may be a central processing unit (CPU) or a semiconductor device that executes instructions stored in the memory 530 or storage 540. The memory 530 and the storage 540 may include various forms of volatile or non-volatile storage media. For example, the memory may include read only memory (ROM) 531 or random access memory (RAM) 532. In the exemplary embodiment of the present disclosure, the memory may be located inside or outside the processor, and the memory may be coupled to the processor through various means already known. Thus, the embodiments may be embodied as a computer-implemented method or as a non-volatile computer-readable medium having computer-executable instructions stored thereon.

In the exemplary embodiment, when executed by a processor, the computer-readable instructions may perform the method according to at least one aspect of the present disclosure. The communication unit 520 may transmit or receive a wired signal or a wireless signal. On the contrary, the embodiments are not implemented only by the apparatuses and/or methods described so far, but may be implemented through a program realizing the function corresponding to the configuration of the embodiment of the present disclosure or a recording medium on which the program is recorded. Such an embodiment can be easily implemented by those skilled in the art from the description of the embodiments described above.

Specifically, methods (e.g., network management methods, data transmission methods, transmission schedule generation methods, etc.) according to embodiments of the present disclosure may be implemented in the form of program instructions that may be executed through various computer means, and be recorded in the computer-readable medium. The computer-readable medium may include program instructions, data files, data structures, and the like, alone or in combination. The program instructions to be recorded on the computer-readable medium may be those specially designed or constructed for the embodiments of the present disclosure or may be known and available to those of ordinary skill in the computer software arts. The computer-readable recording medium may include a hardware device configured to store and execute program instructions.

For example, the computer-readable recording medium can be any type of storage media such as magnetic media like hard disks, floppy disks, and magnetic tapes, optical media like CD-ROMs, DVDs, magneto-optical media like floptical disks, and ROM, RAM, flash memory, and the like. Program instructions may include machine language code such as those produced by a compiler, as well as high-level language code that may be executed by a computer via an interpreter, or the like.

An apparatus for predicting error possibility according to an exemplary embodiment includes a processor 510 and a memory 530, and the processor 510 executes a program stored in the memory 530 to perform: generating a first annotation for input data for training by using an algorithm; performing a machine-learning for an annotation evaluation model based on the first annotation and a correction history for the first annotation; generating a second annotation for input data for evaluating by using the algorithm; and predicting the error probability of the second annotation based on the annotation evaluation model.

While this disclosure has been described in connection with what is presently considered to be practical example embodiments, it is to be understood that this disclosure is not limited to the disclosed embodiments, but, on the contrary, is intended to cover various modifications and equivalent arrangements included within the spirit and scope of the appended claims.

What is claimed is:

1. An apparatus for predicting error possibility in an annotation for input data, the apparatus comprising:
an annotation generating unit configured to generate a first annotation for input data for training and a second annotation for input data for evaluation by using an annotation algorithm;
an annotation learning unit configured to perform a machine-learning for an annotation evaluation model based on the first annotation and a correction history for the first annotation; and
an annotation error predicting unit configured to predict the error probability of the second annotation based on the annotation evaluation model.

2. The apparatus of claim 1, further comprising:
an annotation correction unit including:
a user interface configured to receive the correction history for the first annotation or provides user with the error possibility of the second annotation; and
a storage unit configured to store the correction history.

3. The apparatus of claim 1, wherein:
the annotation learning unit is configured to perform the machine-learning for a binary classification model as the annotation evaluation model,
wherein the binary classification model predicts first input data for which correction has been performed among the input data for training as an error occurrence class for the first annotation and predicts second input data for which correction has not been performed among the input data for training as a no error occurrence class for the first annotation.

4. The apparatus of claim 1, wherein:
the annotation learning unit is configured to perform the machine-learning for a multi classification model as the annotation evaluation model,
wherein the multi classification model classifies errors of the first annotation into a correction class, a deletion class, an addition class, and no error class.

5. The apparatus of claim 3, wherein:
the annotation error predicting unit is configured to calculate an error value which indicates that an error exists in the second annotation.

6. The apparatus of claim 4, wherein:
the annotation error predicting unit is configured to calculate an error value which indicates that a type of an error that occurs in the second annotation is one of the correction class, the deletion class, and the addition class.

7. A method for predicting error possibility in an annotation for input data, the method comprising:
generating a first annotation for input data for training by using an annotation algorithm;
performing a machine-learning for an annotation evaluation model based on the first annotation and a correction history for the first annotation;
generating a second annotation for input data for evaluating by using the annotation algorithm; and
predicting the error probability of the second annotation based on the annotation evaluation model.

8. The method of claim 7, further comprising:
after the predicting of the error probability of the second annotation based on the annotation evaluation model,
providing the error possibility of the second annotation to a user, and receiving the correction history for the second annotation from the user.

9. The method of claim 7,
wherein the performing of the machine-learning for the annotation evaluation model includes:
performing the machine-learning for a binary classification model as the annotation evaluation model,
wherein the binary classification model predicts first input data for which correction has been performed among the input data for training as an error occurrence class for the first annotation and predicts second input data for which correction has not been performed among the input data for training as a no error occurrence class for the first annotation.

10. The method of claim 7, wherein the performing of the machine-learning for the annotation evaluation model includes:
performing the machine-learning for a multi classification model as the annotation evaluation model,
wherein the multi classification model classifies errors of the first annotation into a correction class, a deletion class, an addition class, and no error class.

11. The method of claim 9, wherein the predicting of the error possibility in the second annotation includes calculating an error value which indicates that an error exists in the second annotation.

12. The method of claim 10, wherein the predicting of the error possibility in the second annotation includes calculating an error value which indicates that a type of an error that occurs in the second annotation is one of the correction class, the deletion class, and the addition class.

13. An apparatus for predicting error possibility in an annotation for input data, the apparatus comprising:
a processor and a memory,
wherein the processor executes a program stored in the memory to perform:
generating a first annotation for input data for training by using an annotation algorithm;
performing a machine-learning for an annotation evaluation model based on the first annotation and a correction history for the first annotation;
generating a second annotation for input data for evaluating by using the annotation algorithm; and
predicting the error probability of the second annotation based on the annotation evaluation model.
